(19) United States
(12) Patent Application Publication
(10) Pub. No.: US 2007/0130422 A1
(43) Pub. Date: Jun. 7, 2007

(54) REMOVABLE MEDIUM ACCESS METHOD AND RELATED APPARATUS IN AN OPTICAL DISC DRIVE

(75) Inventors: Jaan-Huei Chen, Taipei Hsien (TW); Kuo-Her Lin, Kaohsiung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: MEDIATEK INC., Hsin-Chu (TW)

(21) Appl. No.: 11/423,736

(22) Filed: Jun. 13, 2006

Related U.S. Application Data
(60) Provisional application No. 60/597,337, filed on Nov. 25, 2005.

(51) Int. Cl. G06F 13/28

(52) U.S. Cl. 711/112

(57) ABSTRACT

The present invention relates to a removable medium access method and related apparatus, and in particular relates to a removable medium access method and related apparatus in an optical disc drive. A removable medium access method for accessing a removable medium in an optical disc drive is provided. The removable medium access method comprises: reading the multimedia data from the removable medium; generating first data; generating a user file wherein the user file comprises at least one set of representation data; writing back the user file and the first data to the removable medium.

### BACKGROUND OF THE INVENTION

1. Field of the Invention

The invention relates to a removable medium access method and related apparatus, and in particular relates to a removable medium access method and related apparatus in an optical disc drive.

2. Description of the Related Art

When an optical disc system is playing or recording data on a removable medium (e.g. DVD disc), various thumbnails (reduced-scaled images or text for mapping to specific titles) must be rendered. It may, however, render the same thumbnail in different situations and thus decreasing performance.

### BRIEF SUMMARY OF THE INVENTION

A detailed description is given in the following embodiments with reference to the accompanying drawings.

A removable medium access method for accessing a removable medium in an optical disc drive is provided. The removable medium access method comprises: reading the multimedia data from the removable medium; generating first data; generating a user file wherein the user file comprises at least one set of representation data; writing back the user file and the first data to the removable medium.

A removable medium access method for accessing a removable medium in an optical disc drive is provided. The removable medium access method comprises: reading the multimedia data from the removable medium; generating first data; generating a user file, wherein the user file comprises at least one set of representation data; generating second data; writing back the user file and the second data to the removable medium.

A removable medium access method for accessing a removable medium in an optical disc drive is provided. The removable medium comprises at least one set of multimedia data and a user file. The removable medium access method comprises: reading the user file from the removable medium; writing new multimedia data to the removable medium; generating first data; modifying the user file; writing back the first data and the user file to the removable medium.

A removable medium access method for accessing a removable medium in an optical disc drive is provided. The removable medium comprises at least one set of multimedia data and a user file. The removable medium access method comprises: reading the user file from the removable medium; writing new multimedia data to the removable medium; generating first data; generating second data; modifying the user file; writing back the first and second data and the user file to the removable medium.

A removable medium access method for accessing a removable medium in an optical disc drive is provided. The removable medium comprises at least one set of multimedia data. The removable medium access method comprises: writing new multimedia data to the removable medium, wherein a portion of the new multimedia data is stored; generating first data; generating a user file according to the kept multimedia data, wherein the user file comprises at least one set of representation data; writing back the first data and the user file to the removable medium.

A removable medium access method for accessing a removable medium in an optical disc drive is provided. The removable medium comprises at least one set of multimedia data. The optical disc drive comprises a memory for storing a user file and new multimedia data. The removable medium access method comprises: writing new multimedia data from the memory to the removable medium; generating first data according to the user file in the memory; writing back the first data and the user file to the removable medium.

### BRIEF DESCRIPTION OF THE DRAWINGS

The present invention can be more fully understood by reading the subsequent detailed description and examples with references made to the accompanying drawings, wherein:

FIG. 1 is a block diagram of an optical disc system according to a first embodiment of the invention;

FIG. 2 is a flow chart of the removable medium access method for accessing the removable medium in FIG. 1;

FIG. 3 is a block diagram of an optical disc system according to a second embodiment of the invention;

FIG. 4 is a flow chart of the removable medium access method for accessing the removable medium in FIG. 3;

FIG. 5 is a block diagram of an optical disc system according to a third embodiment of the invention;

FIG. 6 is a flow chart of the removable medium access method for accessing the removable medium in FIG. 5;

FIG. 7 is a block diagram of an optical disc system according to a fourth embodiment of the invention;

FIG. 8 is a flow chart of the removable medium access method for accessing the removable medium in FIG. 7;

FIG. 9 is a block diagram of an optical disc system according to a fifth embodiment of the invention;

FIG. 10 is a flow chart of the removable medium access method for accessing the removable medium in FIG. 9;

FIG. 11 is a block diagram of an optical disc system according to a fifth embodiment of the invention;

FIG. 12 is a flow chart of the removable medium access method for accessing the removable medium in FIG. 11.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

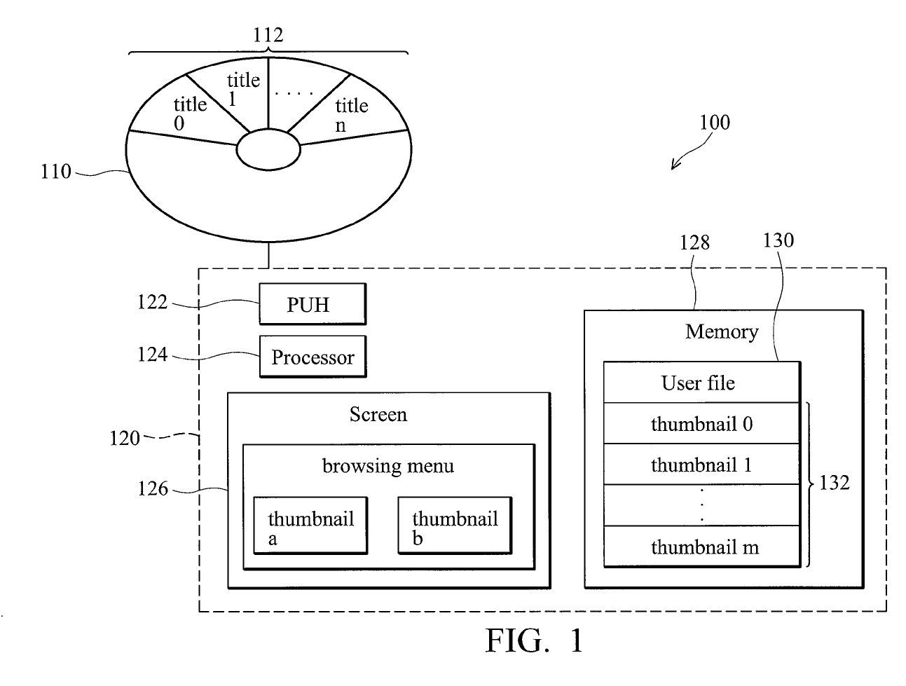

Please refer to FIG. 1. FIG. 1 is a block diagram of an optical disc system 100 according to a first embodiment of the invention. The optical disc system 100 comprises a removable medium 110 (e.g. DVD disc) and an optical disc drive 120. The removable medium 110 comprises a plurality of titles recorded thereon. Different titles represent different movies. The optical disc drive 120 comprises a pick-up head (PUH) 122, a processor 124, a screen 126, and a memory 128 (e.g. DRAM, HDD, or flash). The PUH 122 is utilized to access data from the removable medium 110. The processor 124 controls the operation of the optical disc drive 120. The user directs the processor 124 through various menus on the screen 126 to play or record titles. Please note that each title menu comprises at least one rendered thumbnail (reduced-scaled image or text) in order to assist the user selection. Each title menu comprises at least one rendered thumbnail mapping to a specific title. The rendered thumbnail is also called representation data. The memory 128 is empty in the beginning and a user file 130 comprising pluralities of rendered thumbnails 132 is stored to the memory 128 later. A detailed description of the optical disc system 100 is provided in the following.

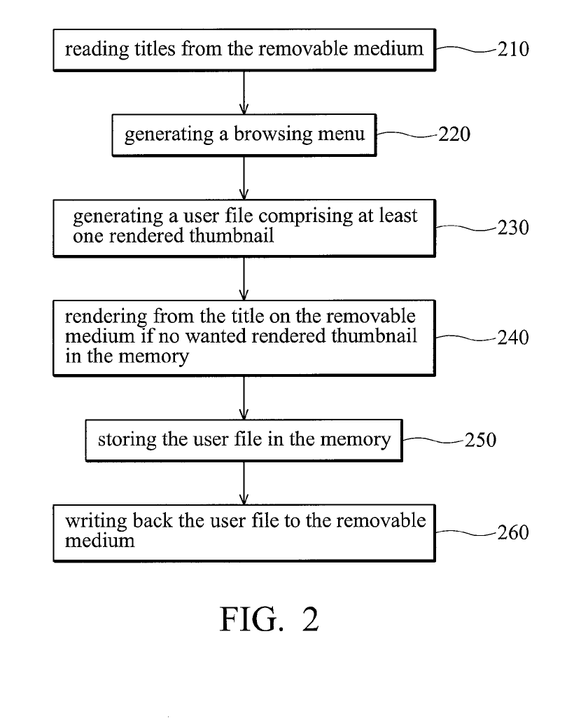

Please refer to FIG. 1 and FIG. 2 at the same time. FIG. 2 is a flow chart of the removable medium access method for accessing the removable medium 110 in the optical disc drive 120. Initially, the PUH 122 reads titles from the removable medium 110 (step 210). The processor 124 generates a browsing menu and a user file 130 (steps 220 and 230). The browsing menu is shown on the screen 126 later to provide specific titles for user selection. The user file 130 comprises at least one rendered thumbnail for pasting onto the browsing menu. If one rendered thumbnail stored in the memory 128 is used to consist the browsing menu, the processor 124 retrieves the rendered thumbnails from the memory and presents the browsing menu on screen 126. Otherwise, if the wanted rendered thumbnails are absent in the memory 128, the processor 124 renders it from titles on the removable medium 110 (step 240), presents the newly rendered thumbnails into the browsing menu, and stores the newly rendered thumbnails to the user file 130. The processor 124 then stores the user file 130 in the memory 128 (step 250). The benefit of storing a user file is that the wanted rendered thumbnail can be pasted onto the browsing menu directly without additional rendering. Finally, the processor 124 writes back the user file 130 to the removable medium 110 (step 260). Additionally, the memory 128 may also store various removable medium identifications (IDs) and title IDs for index of specific titles.

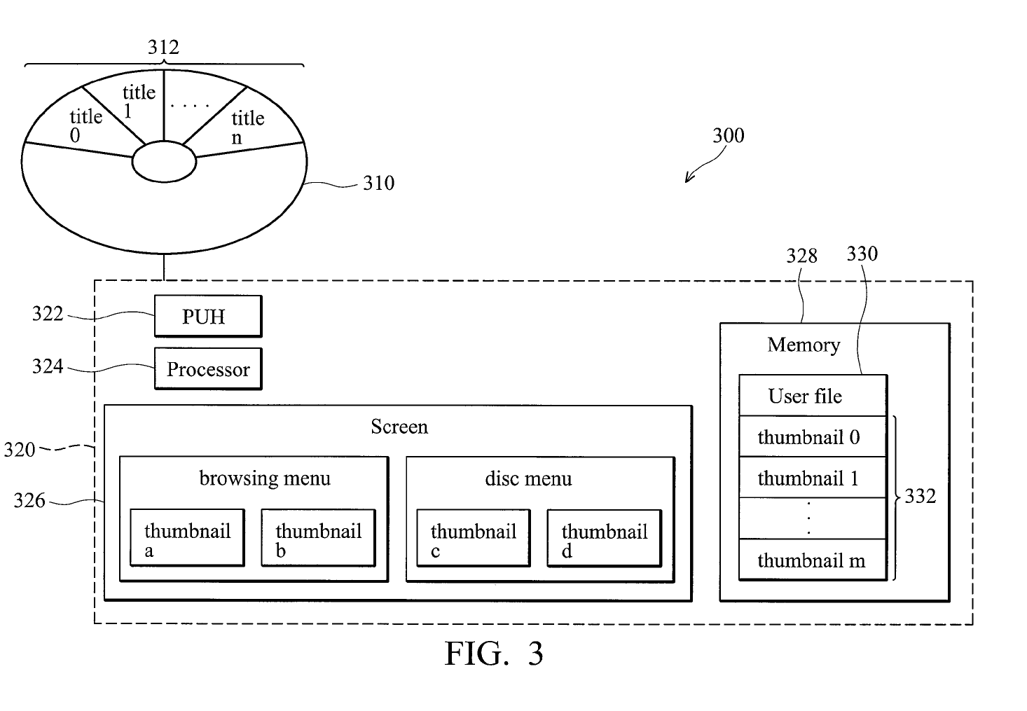

Please refer to FIG. 3. FIG. 3 is a block diagram of an optical disc system 300 according to a second embodiment of the invention. The key difference from the first embodiment is that not only the browsing menu but also the disc menu are generated. The disc menu is the menu stored in the removable medium 310. A detailed description of the optical disc system 300 is provided in the following.

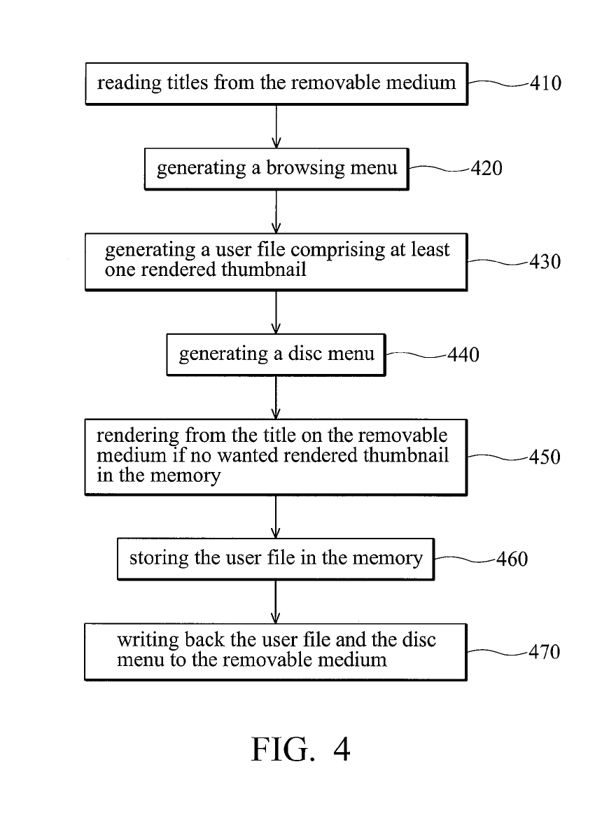

Please refer to FIG. 3 and FIG. 4 at the same time. FIG. 4 is a flow chart of the removable medium access method for accessing the removable medium 310 in the optical disc drive 320. Initially, the PUH 322 reads titles from the removable medium 310 (step 410). The processor 324 respectively generates a browsing menu, a user file 330, and a disc menu (steps 420˜440). The browsing menu is shown on the screen 326 later to provide specific titles for user selection. The user file 330 comprises at least one rendered thumbnail for pasting into the browsing menu. The disc menu is written back to the removable medium 310 later. If the rendered thumbnails in the memory 328 are requested to consist the browsing menu or the disc menu, the processor 324 directly retrieves the rendered thumbnails from the memory 328. Otherwise, if the wanted rendered thumbnails 328 are absent in the memory, the processor 324 renders the rendered thumbnails from several titles on the removable medium 310 (step 450), pastes the newly rendered thumbnails onto the browsing menu or disc menu, and stores the newly rendered thumbnails in the user file 330. The processor 324 then stores the user file 330 in the memory 328 (step 460). The benefit of storing a user file is that the wanted rendered thumbnail can be pasted onto the browsing menu or disc menu directly from the memory without additional rendering steps. Finally, the processor 324 writes back the user file 330 and the disc menu to the removable medium 310 (step 470). Please note that the memory 328 may also store various removable medium identifications (IDs) and title IDs for index of specific titles. Additionally, different rendered thumbnails in the memory 328 may have different priorities. For example, a title thumbnail has a higher priority than other kinds of thumbnails.

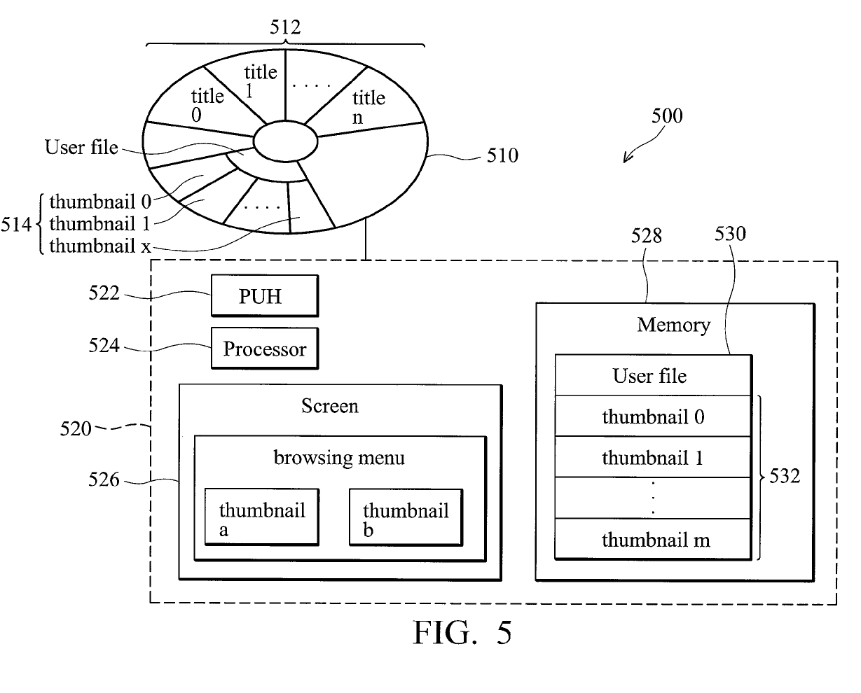

Please refer to FIG. 5. FIG. 5 is a block diagram of an optical disc system 500 according to a third embodiment of the invention. The key difference from the first embodiment is that in this embodiment there is a user file in the removable medium at the beginning. Additionally, the processor 524 further records a new title later. A detailed description of the optical disc system 300 is provided in the following.

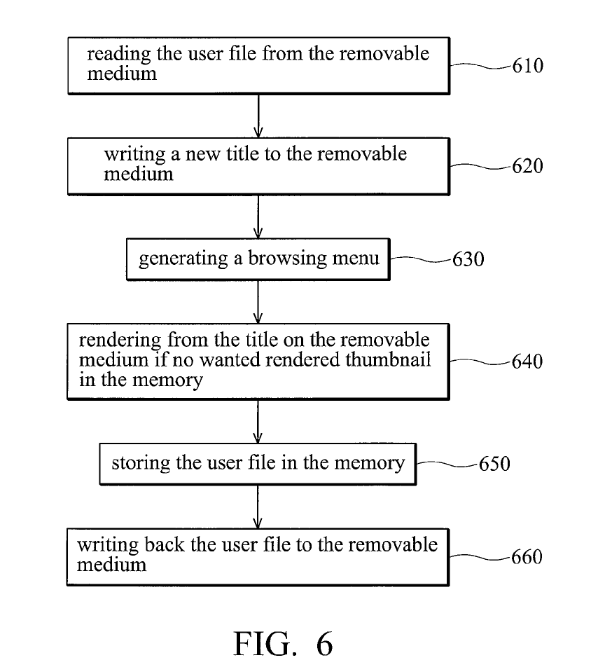

Please refer to FIG. 5 and FIG. 6 at the same time. FIG. 6 is a flow chart of the removable medium access method for accessing the removable medium 510 in the optical disc drive 520. Initially, the PUH 522 reads titles and a user file from the removable medium 510 (step 610). The processor 524 then writes a new title to the removable medium 510 (step 620) and generates a browsing menu (step 630). The browsing menu is shown on the screen 526 later to provide specific titles for user selection. The user file 530 copied from the removable medium 510 comprises at least one rendered thumbnail for pasting onto the browsing menu. If any rendered thumbnail in the memory 528 is wanted by the browsing menu, the processor 524 directly pastes the wanted rendered thumbnails onto the browsing menu and shows the browsing menu on screen 526. Otherwise, if the wanted rendered thumbnails are absent in the memory 528, the processor 524 renders from titles on the removable medium 510 (step 640), pastes the newly rendered thumbnails onto the browsing menu, and stores the newly rendered thumbnails to the user file 530. The processor 524 then stores the user file 530 in the memory 528 (step 650). The benefit of storing a user file is that next time the wanted rendered thumbnail can be pasted onto the browsing menu directly without additional rendering. Finally, the processor 524 writes back the modified user file 530 to the removable medium 510 (step 660). Additionally, the memory 528 may also store various removable medium identifications (IDs) and title IDs for index of specific titles.

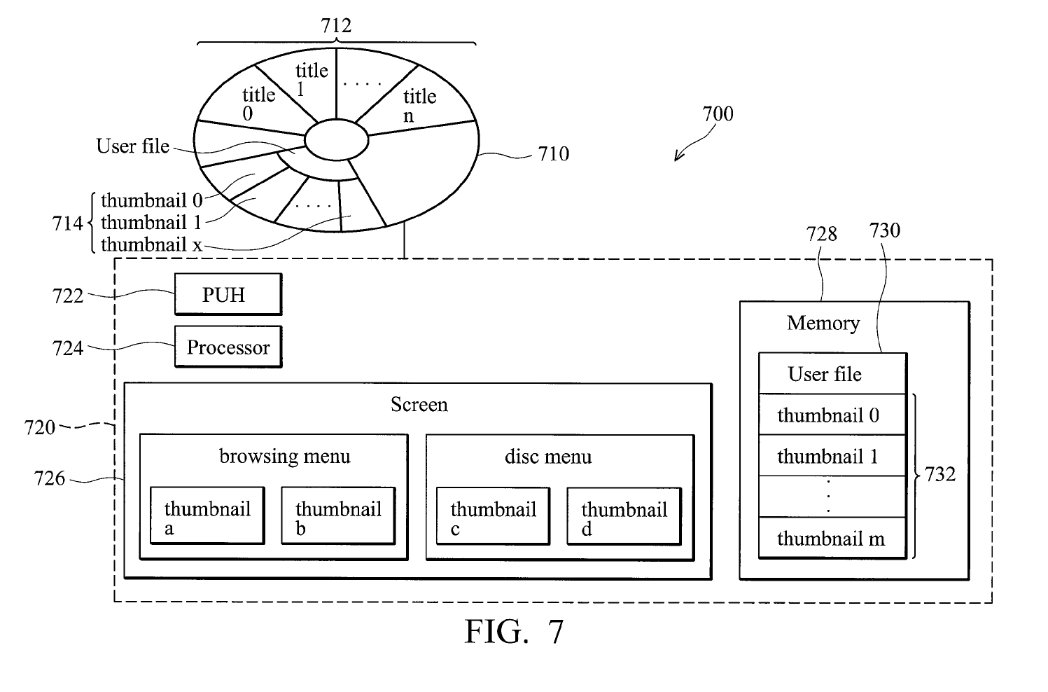

Please refer to FIG. 7. FIG. 7 is a block diagram of an optical disc system 700 according to a fourth embodiment of the invention. The key difference from the third embodiment is that not only the browsing menu but also the disc menu are generated. The disc menu is the menu stored in the removable medium 710. A detailed description of the optical disc system 700 is provided in the following.

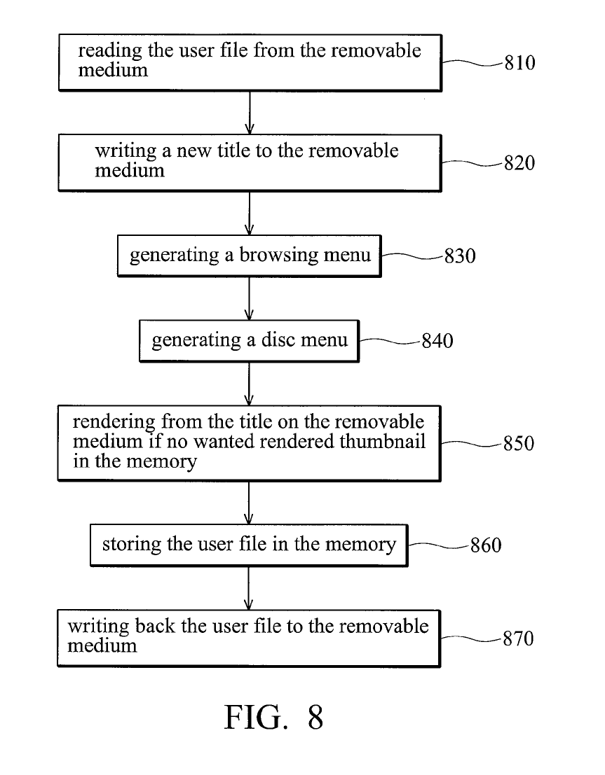

Please refer to FIG. 7 and FIG. 8 at the same time. FIG. 8 is a flow chart of the removable medium access method for accessing the removable medium 710 in the optical disc drive 720. Initially, the PUH 722 reads titles and a user file from the removable medium 710 (step 810). The processor 724 then writes a new title to the removable medium 710 (step 820) and generates a browsing menu and a disc menu (steps 830 and 840). The browsing menu is shown on the screen 726 later to provide specific titles for user selection. The user file 730 copied from the removable medium 710 comprises at least one rendered thumbnail for pasting onto the browsing menu. If a rendered thumbnail in the memory 728 is wanted by the browsing menu, the processor 724 directly pastes the wanted rendered thumbnails onto the browsing menu and presents the browsing menu on screen 726. Otherwise, if the rendered thumbnails in the memory 728 are not wanted by the browsing menu, the processor 724 renders from titles on the removable medium 710 (step 850), pastes the newly rendered thumbnails to the browsing menu, and stores the newly rendered thumbnails to the user file 730. The processor 724 then stores the user file 730 in the memory 728 (step 860). The benefit of storing a user file is that next time the wanted rendered thumbnail can be pasted into the browsing menu directly without additional rendering. Finally, the processor 724 writes back the modified user file 730 to the removable medium 710 (step 870). Additionally, the memory 728 may also store various removable medium identifications (IDs) and title IDs for index of specific titles.

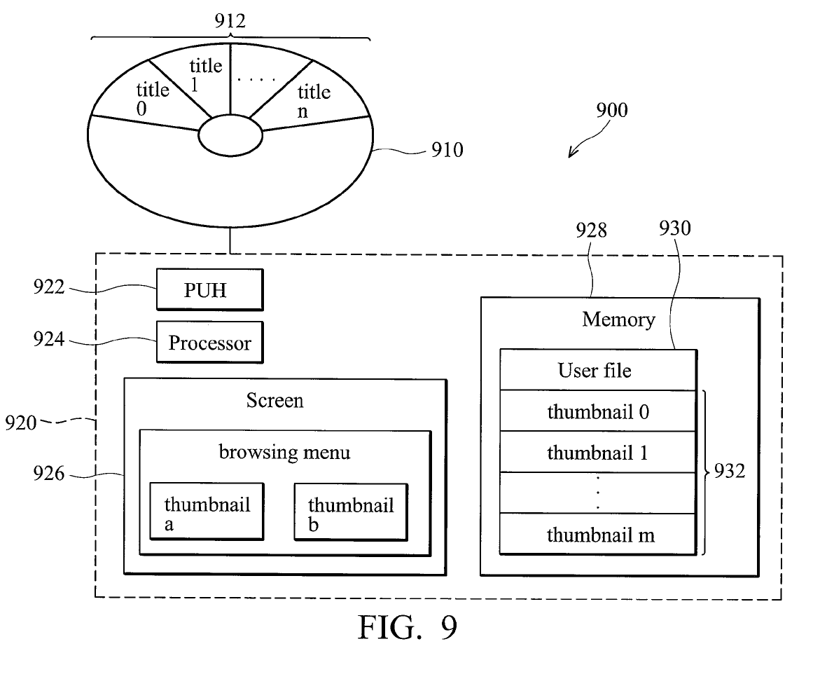

Please refer to FIG. 9. FIG. 9 is a block diagram of an optical disc system 900 according to a fifth embodiment of the invention. The key difference from the first embodiment is that the processor 924 further records a new title to the removable medium 910. Please note that the memory 928 is empty in the beginning and a user file 930 comprising pluralities of rendered thumbnails 932 is stored to the memory 928 later. A detailed description of the optical disc system 900 is provided in the following.

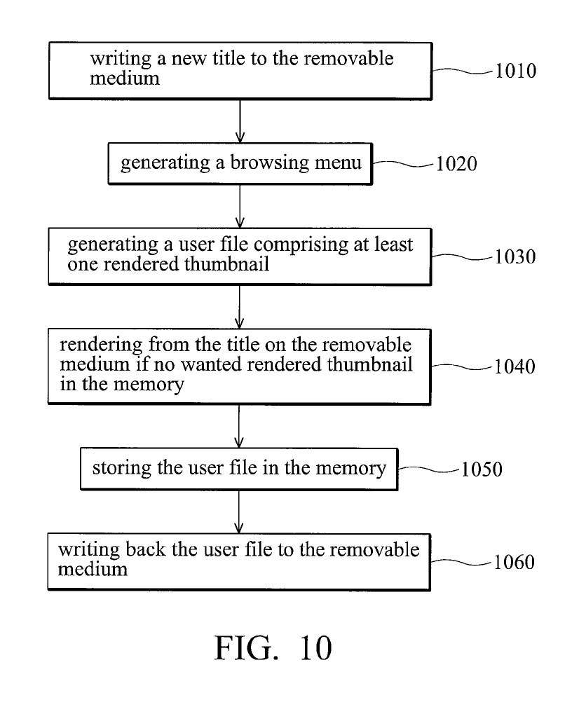

Please refer to FIG. 9 and FIG. 10 at the same time. FIG. 10 is a flow chart of the removable medium access method for accessing the removable medium 910 in the optical disc drive 920. Initially, the processor 924 writes a new title to the removable medium 910 and temporarily stores parts of the new title (step 1010). The processor 924 renders thumbnail from the temporarily parts of the new title and stores the temporarily parts in the user file 930. The processor 924 generates a browsing menu and a user file 930 (steps 1020 and 1030). The browsing menu is shown on the screen 926 later to provide specific titles for user selection. The user file 930 is generated according to the stored new title and comprises at least one rendered thumbnail for pasting onto the browsing menu. If any rendered thumbnail in the memory 928 is wanted by the browsing menu, the processor 924 directly pastes the wanted rendered thumbnails into the browsing menu and shows the browsing menu on screen 926. Otherwise, if the rendered thumbnails in the memory 928 are not wanted by the browsing menu, the processor 924 renders from titles on the removable medium 910 (step 1040), pastes the newly rendered thumbnails into the browsing menu, and stores the newly rendered thumbnails in the user file 930. The processor 1924 then stores the user file 930 in the memory 928 (step 1050). The benefit of storing a user file is that next time the wanted rendered thumbnail can be pasted to the browsing menu directly without additional rendering. Finally, the processor 924 writes back the user file 930 to the removable medium 910 (step 1060). Additionally, the memory 928 may also store various removable medium identifications (IDs) and title IDs for index of specific titles.

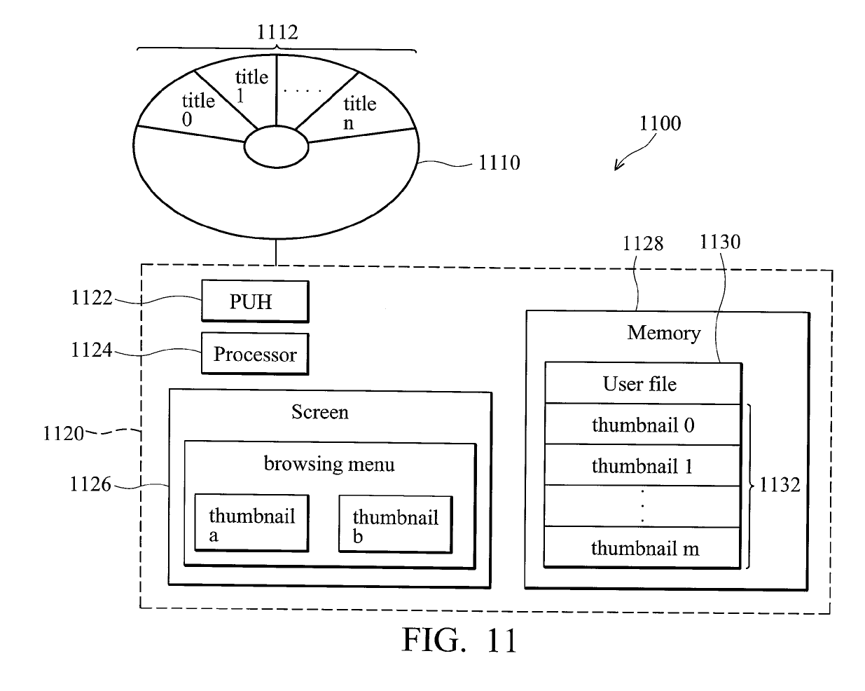

Please refer to FIG. 11. FIG. 11 is a block diagram of an optical disc system 1100 according to a fifth embodiment of the invention. The key difference from the fourth embodiment is that in this embodiment there is a user file in the removable medium at the beginning. A detailed description of the optical disc system 1100 is provided in the following.

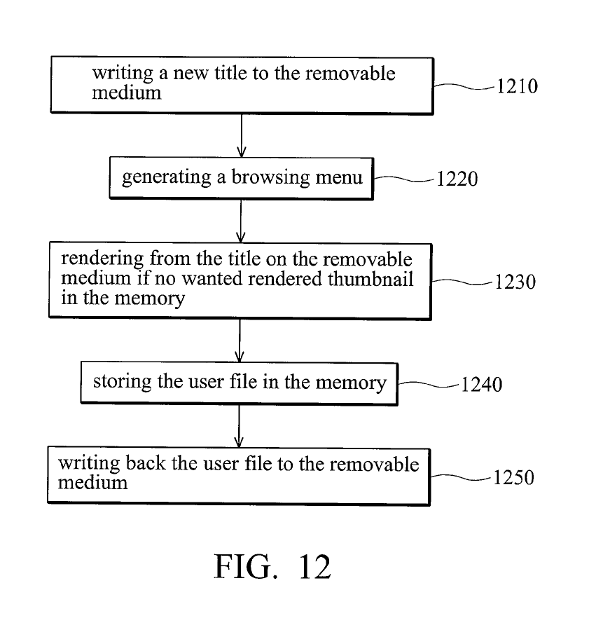

Please refer to FIG. 11 and FIG. 12 at the same time. FIG. 12 is a flow chart of the removable medium access method for accessing the removable medium 1110 in the optical disc drive 1120. Initially, the PUH 1122 writes a new title to the removable medium 1110 (step 1210). The processor 1124 then generates a browsing menu (step 1220). The browsing menu is shown on the screen 1126 later to provide specific titles for user selection. The user file 1130 copied from the removable medium 1110 comprises at least one rendered thumbnail for pasting into the browsing menu. If any rendered thumbnail in the memory 1128 is wanted by the browsing menu, the processor 1124 directly pastes the wanted rendered thumbnails into the browsing menu and shows the browsing menu on screen 1126. Otherwise, if the rendered thumbnails in the memory 1128 are not wanted by the browsing menu, the processor 1124 renders from titles on the removable medium 1110 (step 1230), pastes the newly rendered thumbnails to the browsing menu, and stores the newly rendered thumbnails to the user file 1130. The processor 1124 then stores the user file 1130 in the memory 1128 (step 1240). The benefit of storing a user file is that next time the wanted rendered thumbnail can be pasted to the browsing menu directly without additional rendering. Finally, the processor 1124 writes back the modified user file 1130 to the removable medium 1110 (step 1250). Additionally, the memory 1128 may also store various removable medium identifications (IDs) and title IDs for index of specific titles.

Compared with the related art, the removable medium access methods and devices of the invention manage and cache the rendered thumbnails in the memory. The optical disc system does not need to render the same thumbnail in different situations and thus performance is increased.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A removable medium access method for accessing a removable medium in an optical disc drive, said removable medium comprising multimedia data, the removable medium access method comprising:
reading the multimedia data from the removable medium;
generating first data;
generating a user file wherein the user file comprises at least one set of representation data; and
writing back the user file and the first data to the removable medium.

2. The removable medium access method as claimed in claim 1 further comprising:
providing a memory to the optical disc drive for storing the user file.

3. The removable medium access method as claimed in claim 2 further comprising:
rendering data from the multimedia data on the removable medium if a wanted representation data of the user file is not in the memory.

4. The removable medium access method as claimed in claim 1 further comprising:
providing a memory to the optical disc drive for storing a representation data with a removable medium ID and a multimedia data ID.

5. The removable medium access method as claimed in claim 4 further comprising:
utilizing the removable medium ID and the multimedia data ID for index of multimedia data.

6. A removable medium access method for accessing a removable medium in an optical disc drive, said removable medium comprising multimedia data, the removable medium access method comprising:
reading the multimedia data from the removable medium;
generating first data;
generating a user file, wherein the user file comprises at least one set of representation data;
generating second data; and
writing back the user file and the second data to the removable medium.

7. The removable medium access method as claimed in claim 6 further comprising:
providing a memory to the optical disc drive for storing the user file.

8. The removable medium access method as claimed in claim 7, wherein each representation data of the user file has priority.

9. The removable medium access method as claimed in claim 6 further comprising:
rendering data from the multimedia data on the removable medium if a wanted representation data of the user file is not in the memory.

10. The removable medium access method as claimed in claim 6 further comprising:
providing a memory to the optical disc drive for storing a representation data with a removable medium ID and a multimedia data ID.

11. The removable medium access method as claimed in claim 10 further comprising:
utilizing the removable medium ID and the multimedia data ID for index of multimedia data.

12. A removable medium access method for accessing a removable medium in an optical disc drive, said removable medium comprising at least one set of multimedia data and a user file, the removable medium access method comprising:
reading the user file from the removable medium;
writing new multimedia data to the removable medium;
generating first data;
modifying the user file; and
writing back the first data and the user file to the removable medium.

13. The removable medium access method as claimed in claim 12 further comprising:
providing a memory to the optical disc drive for storing the user file.

14. The removable medium access method as claimed in claim 13, wherein each representation data of the user file has priority index.

15. The removable medium access method as claimed in claim 12 further comprising:
reading data from the user file on the removable medium if a wanted representation data of the user file is not in the memory.

16. The removable medium access method as claimed in claim 15 further comprising:
rendering data from the multimedia data on the removable medium if the wanted representation data of the user file is not in the removable medium.

17. The removable medium access method as claimed in claim 12 further comprising:
providing a memory to the optical disc drive for storing representation data with a removable medium ID and a multimedia data ID.

18. The removable medium access method as claimed in claim 17 further comprising:
utilizing the removable medium ID and the multimedia data ID for index of multimedia data.

19. A removable medium access method for accessing a removable medium in an optical disc drive, said removable medium comprising at least one set of multimedia data and a user file, the removable medium access method comprising:
reading the user file from the removable medium;
writing new multimedia data to the removable medium;
generating first data;
generating second data;
modifying the user file; and
writing back the first and second data and the user file to the removable medium.

20. The removable medium access method as claimed in claim 19 further comprising:
providing a memory to the optical disc drive for storing the user file.

21. The removable medium access method as claimed in claim 20, wherein each representation data of the user file has priority index.

22. The removable medium access method as claimed in claim 19 further comprising:
reading data from the user file on the removable medium if a wanted representation data of the user file is not in the memory.

23. The removable medium access method as claimed in claim 22 further comprising:
rendering data from the multimedia data on the removable medium if the wanted representation data of the user file is not in the removable medium.

24. The removable medium access method as claimed in claim 19 further comprising:
providing a memory to the optical disc drive for storing representation data with a removable medium ID and a multimedia data ID.

25. The removable medium access method as claimed in claim 24 further comprising:
utilizing the removable medium ID and the multimedia data ID for index of multimedia data.

26. A removable medium access method for accessing a removable medium in an optical disc drive, said removable medium comprising at least one set of multimedia data, the removable medium access method comprising:
writing new multimedia data to the removable medium, wherein a portion of the new multimedia data is stored;
generating first data;
generating a user file according to the kept multimedia data, wherein the user file comprises at least one set of representation data; and
writing back the first data and the user file to the removable medium.

27. A removable medium access method for accessing a removable medium in an optical disc drive, said removable medium comprising at least one set of multimedia data, said optical disc drive comprising a memory for storing a user file and new multimedia data, the removable medium access method comprising:
writing new multimedia data from the memory to the removable medium;
generating first data according to the user file in the memory; and
writing back the first data and the user file to the removable medium.

28. A removable medium accessing apparatus for accessing a removable medium in an optical disc drive, said removable medium comprising multimedia data, the removable medium accessing apparatus comprising:
means for reading the multimedia data from the removable medium;
means for generating first data;
means for generating a user file wherein the user file comprises at least one set of representation data; and
means for writing back the user file and the first data to the removable medium.

29. The removable medium accessing apparatus as claimed in claim 28 further comprising:
means for providing a memory to the optical disc drive for storing the user file.

30. The removable medium accessing apparatus as claimed in claim 29 further comprising:
means for rendering data from the multimedia data on the removable medium if a wanted representation data of the user file is not in the memory.

31. The removable medium accessing apparatus as claimed in claim 28 further comprising:
means for providing a memory to the optical disc drive for storing a removable medium ID and a multimedia data ID.

32. The removable medium accessing apparatus as claimed in claim 31 further comprising:
means for utilizing the removable medium ID and the multimedia data ID for index of multimedia data.

33. A removable medium accessing apparatus for accessing a removable medium in an optical disc drive, said removable medium comprising multimedia data, the removable medium accessing apparatus comprising:
means for reading the multimedia data from the removable medium;
means for generating first data;
means for generating a user file, wherein the user file comprises at least one set of representation data;
means for generating second data; and
means for writing back the user file and the second data to the removable medium.

34. The removable medium accessing apparatus as claimed in claim 33 further comprising:
means for providing a memory to the optical disc drive for storing the user file.

35. The removable medium accessing apparatus as claimed in claim 34, wherein each representation data of the user file has priority index.

36. The removable medium accessing apparatus as claimed in claim 33 further comprising:
means for rendering data from the multimedia data on the removable medium if a wanted representation data of the user file is not in the memory.

37. The removable medium accessing apparatus as claimed in claim 33 further comprising:
means for providing a memory to the optical disc drive for storing a removable medium ID and a multimedia data ID.

38. The removable medium accessing apparatus as claimed in claim 37 further comprising:
means for utilizing the removable medium ID and the multimedia data ID for index of multimedia data.

39. A removable medium accessing apparatus for accessing a removable medium in an optical disc drive, said removable medium comprising at least one set of multimedia data and a user file, the removable medium accessing apparatus comprising:
means for reading the user file from the removable medium;
means for writing new multimedia data to the removable medium;
means for generating first data;
means for modifying the user file; and
means for writing back the first data and the user file to the removable medium.

40. The removable medium accessing apparatus as claimed in claim 39 further comprising:
means for providing a memory to the optical disc drive for storing the user file.

41. The removable medium accessing apparatus as claimed in claim 40, wherein each representation data of the user file has priority index.

42. The removable medium accessing apparatus as claimed in claim 39 further comprising:
means for reading data from the user file on the removable medium if a wanted representation data of the user file is not in the memory.

43. The removable medium accessing apparatus as claimed in claim 42 further comprising:
means for rendering data from the multimedia data on the removable medium if a wanted representation data of the user file is not in the removable medium.

44. The removable medium accessing apparatus as claimed in claim 39 further comprising:
means for providing a memory to the optical disc drive for storing a removable medium ID and a multimedia data ID.

45. The removable medium accessing apparatus as claimed in claim 44 further comprising:
means for utilizing the removable medium ID and the multimedia data ID for index of multimedia data.

46. A removable medium accessing apparatus for accessing a removable medium in an optical disc drive, said removable medium comprising at least one set of multimedia data and a user file, the removable medium accessing apparatus comprising:
means for reading the user file from the removable medium;
means for writing new multimedia data to the removable medium;
means for generating first data;
means for generating second data;
means for modifying the user file; and
means for writing back the first and second data and the user file to the removable medium.

47. The removable medium accessing apparatus as claimed in claim 46 further comprising:
means for providing a memory to the optical disc drive for storing the user file.

48. The removable medium accessing apparatus as claimed in claim 47, wherein each representation data of the user file has priority index.

49. The removable medium accessing apparatus as claimed in claim 46 further comprising:
means for reading data from the user file on the removable medium if a wanted representation data of the user file is not in the memory.

50. The removable medium accessing apparatus as claimed in claim 49 further comprising:
means for rendering data from the multimedia data on the removable medium if a wanted representation data of the user file is not in the removable medium.

51. The removable medium accessing apparatus as claimed in claim 46 further comprising:
means for providing a memory to the optical disc drive for storing a removable medium ID and a multimedia data ID.

52. The removable medium accessing apparatus as claimed in claim 51 further comprising:
means for utilizing the removable medium ID and the multimedia data ID for index of multimedia data.

53. A removable medium accessing apparatus for accessing a removable medium in an optical disc drive, said removable medium comprising at least one set of multimedia data, the removable medium accessing apparatus comprising:
means for writing new multimedia data to the removable medium, wherein partial of the new multimedia data;
means for generating first data;
means for generating a user file according to the kept multimedia data, wherein the user file comprises at least one set of representation data; and
means for writing back the first data and the user file to the removable medium.

54. A removable medium accessing apparatus for accessing a removable medium in an optical disc drive, said removable medium comprising at least one set of multimedia data, said optical disc drive comprising a memory for storing a user file and new multimedia data, the removable medium accessing apparatus comprising:
means for writing new multimedia data from the memory to the removable medium;
means for generating first data according to the user file in the memory; and
means for writing back the first data and the user file to the removable medium.

55. A removable medium accessing apparatus for accessing a removable medium in an optical disc drive, said removable medium comprising multimedia data, the removable medium accessing apparatus comprising:
a pick-up head (PUH) for reading the multimedia data from the removable medium; and
a processor for generating first data and a user file and writing back the user file and the first data to the removable medium;
wherein the user file comprises at least one set of representation data.

56. The removable medium accessing apparatus as claimed in claim 55 further comprising:
a memory for storing the user file.

57. The removable medium accessing apparatus as claimed in claim 56 wherein the processor renders data from the multimedia data on the removable medium if a wanted representation data of the user file is not in the memory.

58. The removable medium accessing apparatus as claimed in claim 55 further comprising:
a memory for storing a removable medium ID and a multimedia data ID.

59. The removable medium accessing apparatus as claimed in claim 58 wherein the processor utilizes the removable medium ID and the multimedia data ID for index of multimedia data.

60. A removable medium accessing apparatus for accessing a removable medium in an optical disc drive, said removable medium comprising multimedia data, the removable medium accessing apparatus comprising:
a pick-up head (PUH) for reading the multimedia data from the removable medium; and
a processor for generating first data, a user file, and a second data, and writing back the user file and the second data to the removable medium;
wherein the user file comprises at least one set of representation data.

61. The removable medium accessing apparatus as claimed in claim 60 further comprising:
a memory for storing the user file.

62. The removable medium accessing apparatus as claimed in claim 61, wherein each representation data of the user file has priority index.

63. The removable medium accessing apparatus as claimed in claim 60 wherein the processor renders data from the multimedia data on the removable medium if a wanted representation data of the user file is not in the memory.

64. The removable medium accessing apparatus as claimed in claim 60 further comprising:
a memory for storing a removable medium ID and a multimedia data ID.

65. The removable medium accessing apparatus as claimed in claim 64 wherein the processor utilizes the removable medium ID and the multimedia data ID for index of multimedia data.

66. A removable medium accessing apparatus for accessing a removable medium in an optical disc drive, said removable medium comprising at least one set of multimedia data and a user file, the removable medium accessing apparatus comprising:
a pick-up head (PUH) for reading the user file from the removable medium; and
a processor for writing new multimedia data to the removable medium, generating first data, modifying the user file, and writing back the first data and the user file to the removable medium.

67. The removable medium accessing apparatus as claimed in claim 66 further comprising:
a memory for storing the user file.

68. The removable medium accessing apparatus as claimed in claim 67, wherein each representation data of the user file has priority index.

69. The removable medium accessing apparatus as claimed in claim 66 wherein the PUH reads data from the user file on the removable medium if a wanted representation data of the user file is not in the memory.

70. The removable medium accessing apparatus as claimed in claim 42 wherein the processor renders data from the multimedia data on the removable medium if a wanted representation data of the user file is not in the removable medium.

71. The removable medium accessing apparatus as claimed in claim 66 further comprising:
a memory for storing a removable medium ID and a multimedia data ID.

72. The removable medium accessing apparatus as claimed in claim 71 wherein the processor utilizes the removable medium ID and the multimedia data ID for index of multimedia data.

73. A removable medium accessing apparatus for accessing a removable medium in an optical disc drive, said removable medium comprising at least one set of multimedia data and a user file, the removable medium accessing apparatus comprising:
a pick-up head (PUH) for reading the user file from the removable medium; and
a processor for writing new multimedia data to the removable medium, generating first data, generating second data, modifying the user file, and writing back the first and second data and the user file to the removable medium.

74. The removable medium accessing apparatus as claimed in claim 73 further comprising:
a memory for storing the user file.

75. The removable medium accessing apparatus as claimed in claim 74, wherein each representation data of the user file has priority index.

76. The removable medium accessing apparatus as claimed in claim 73 wherein the PUH reads data from the user file on the removable medium if a wanted representation data of the user file is not in the memory.

77. The removable medium accessing apparatus as claimed in claim 76 wherein the processor renders data from the multimedia data on the removable medium if a wanted representation data of the user file is not in the removable medium.

78. The removable medium accessing apparatus as claimed in claim 73 further comprising:
a memory for storing a removable medium ID and a multimedia data ID.

79. The removable medium accessing apparatus as claimed in claim 78 wherein the processor utilizes the removable medium ID and the multimedia data ID for index of multimedia data.

80. A removable medium accessing apparatus for accessing a removable medium in an optical disc drive, said removable medium comprising at least one set of multimedia data, the removable medium accessing apparatus comprising:
a processor for writing new multimedia data to the removable medium and keeping partial of the new multimedia data, generating first data, generating a user file according to the kept multimedia data, and writing back the first data and the user file to the removable medium;
wherein the user file comprises at least one set of representation data.

81. A removable medium accessing apparatus for accessing a removable medium in an optical disc drive, said removable medium comprising at least one set of multimedia data, said optical disc drive comprising a memory for storing a user file and new multimedia data, the removable medium accessing apparatus comprising:
a processor for writing new multimedia data from the memory to the removable medium, generating first data according to the user file in the memory, and writing back the first data and the user file to the removable medium.

82. An optical disc system comprising:
a removable medium; and
an optical disc drive, wherein the optical disc drive comprises:
a pick-up head (PUH) for reading multimedia data from the removable medium; and
a processor for generating first data and a user file and writing back the user file and the first data to the removable medium;
wherein the user file comprises at least one set of representation data.

83. An optical disc system comprising:
a removable medium; and
an optical disc drive, wherein the optical disc drive comprises:
a pick-up head (PUH) for reading multimedia data from the removable medium; and
a processor for generating first data, a user file, and a second data, and writing back the user file and the second data to the removable medium;
wherein the user file comprises at least one set of representation data.

84. An optical disc system comprising:
a removable medium; and
an optical disc drive, wherein the optical disc drive comprises:
a pick-up head (PUH) for reading multimedia data from the removable medium; and
a processor for writing new multimedia data to the removable medium, generating first data, modifying the user file, and writing back the first data and the user file to the removable medium.

85. An optical disc system comprising:
a removable medium; and
an optical disc drive, wherein the optical disc drive comprises:
a pick-up head (PUH) for reading multimedia data from the removable medium; and
a processor for writing new multimedia data to the removable medium, generating first data, generating second data, modifying the user file, and writing back the first and second data and the user file to the removable medium.

86. An optical disc system comprising:
a removable medium; and
an optical disc drive, wherein the optical disc drive comprises:
a processor for writing new multimedia data to the removable medium and keeping partial of the new multimedia data, generating first data, generating a user file according to the kept multimedia data, and writing back the first data and the user file to the removable medium;
wherein the user file comprises at least one set of representation data.

87. An optical disc system comprising:
a removable medium; and
an optical disc drive, wherein the optical disc drive comprises:
a processor for writing new multimedia data from the memory to the removable medium, generating first data according to the user file in the memory, and writing back the first data and the user file to the removable medium.
